(19) United States
(12) Patent Application Publication
(10) Pub. No.: US 2025/0266057 A1
(43) Pub. Date: Aug. 21, 2025

(54) DISK DRIVE SUSPENSION

(71) Applicant: NHK SPRING CO., LTD., Yokohama-shi (JP)

(72) Inventor: Yukie YAMADA, Yokohama-shi (JP)

(73) Assignee: NHK SPRING CO., LTD., Yokohama-shi (JP)

(21) Appl. No.: 19/050,136

(22) Filed: Feb. 11, 2025

(30) Foreign Application Priority Data
Feb. 15, 2024 (JP) 2024-021017

(51) Int. Cl. G11B 5/48

(52) U.S. Cl. CPC G11B 5/4833

(57) ABSTRACT

A slider arrangement portion on which a slider is arranged is formed on a flexure of a suspension. The slider arrangement portion includes an aperture portion. The aperture portion is formed on a metal base of the flexure. The aperture portion is provided at a position on which the slider is provided. The aperture portion is open in a thickness direction of the metal base. A conductor portion is embedded in a resin member filling the aperture portion. A slider support portion is formed on a first surface of the resin member. An abutting portion is formed on a second surface of the resin member. The abutting portion contacts a protrusion portion of a dimple portion.

### CROSS-REFERENCE TO RELATED APPLICATIONS

This application is based upon and claims the benefit of priority from prior Japanese Patent Application No. 2024-021017, filed Feb. 15, 2024, the entire contents of which are incorporated herein by reference.

### BACKGROUND OF THE INVENTION

### 1. Field of the Invention

The present invention relates to a disk drive suspension comprising a load beam, a flexure, and the like.

### 2. Description of the Related Art

A disk drive is used in an information processing apparatus such as a personal computer. A disk drive includes a magnetic disk rotating around a spindle, a carriage pivoting about a pivot, and the like. A disk drive suspension is provided on an arm of the carriage.

The disk drive suspension comprises a baseplate, a load beam, a flexure arranged along the load beam, and the like. The flexure includes a metal base composed of a thin stainless steel plate and a circuit portion provided along the metal base. The disk drive suspension is simply called a suspension hereinafter.

A swingable gimbal structure is formed near the tip of the flexure. The gimbal structure includes a slider arrangement portion on which the slider is arranged. A part of the flexure constituting the slider arrangement portion is called a tongue as well. The tongue is formed on a portion of the metal base. The gimbal structure is supported by a protrusion portion formed on the load beam. The protrusion portion is called a dimple as well in the industry. The apex of the protrusion portion (the apex of the dimple) supports the tongue in a swingable manner.

A slider functioning as a magnetic head is attached to the slider arrangement portion. The slider includes elements for accessing data such as reading or writing of data stored in a disk. The disk rotates, producing an air bearing between the slider and the disk. The distance between an air bearing formation surface of the slider and the disk surface (Head Media Spacing) is, for example, 10 nm or less. That is, the distance is significantly small.

JP 4993524 B (Patent Literature 1) discloses an example of the slider and the circuit portion. The circuit portion is connected to the slider. The circuit portion of Patent Literature 1 extends in the length direction of the flexure along a side surface and the other side surface of the slider. The slider is secured to a metal base of the flexure by bonding and the like. In this case, both sides of the slider necessitate space for the circuit portion. This configuration is disadvantageous for achieving more compact suspensions.

JP 5931624 B (Patent Literature 2) discloses another example of the suspension. The suspension includes a circuit portion between the rear surface of a slider and a metal base. That is, the metal base, the circuit portion, and the slider overlap in the thickness direction. In this case, an adhesive secures the rear surface of the slider to the circuit portion. This configuration can reduce the width of the slider arrangement portion and thus is advantageous for achieving more compact suspensions.

In the suspension of Patent Literature 2, the circuit portion and the slider overlap in the thickness direction. The circuit portion includes a plurality of independent conductors each covered by a cover resin. Thus, when these conductors and the cover resin are not flush with one another, the slider is inaccurately oriented, which is disadvantageous. Further, the metal base, the circuit portion, and the slider overlap in the thickness direction. This configuration further disadvantageously increases the distance between the apex of the dimple and the air bearing formation surface of the slider by the thickness of the circuit portion.

The present invention aims to provide a suspension capable of stabling an orientation of a slider provided on the slider arrangement portion.

### BRIEF SUMMARY OF THE INVENTION

An embodiment is a disk drive suspension comprising a load beam and a flexure. The flexure includes a metal base, a slider arrangement portion on which a slider is arranged, and a circuit portion electrically connected to the slider. The slider arrangement portion includes an aperture portion formed in the metal base and a resin member filling the aperture portion, and a conductor portion. The aperture portion is formed in a position on which the slider is arranged and is open toward a thickness direction of the metal base. The conductor portion is a part of the circuit portion and is embedded in the resin member. A slider support portion on which the slider is arranged is formed on a first surface of the resin member in the thickness direction. An abutting portion abutting a protrusion portion (the apex of a dimple portion) of the load beam is formed on a second surface of the resin member in the thickness direction.

An embodiment of the present invention can stable the orientation of the slider provided on the slider arrangement portion, in the disk drive suspension comprising the slider, the circuit portion, and the like.

In the suspension of the present embodiment, the resin member may include a base resin layer and an embedding resin. The base resin layer is formed inside the aperture portion. The embedding resin fills the aperture portion. The embedding resin overlaps the base resin layer with the conductor portion being embedded. An auxiliary member contacting the protrusion portion may be provided on the abutting portion. The resin member may have a thickness smaller than that of the metal base.

The resin member may include: a base resin layer formed inside the aperture portion; an embedding resin; and a foundation resin. The embedding resin overlaps a surface of the base resin layer with the conductor portion being embedded. The foundation resin overlaps an opposite surface of the base resin layer. The resin member may be composed of an embedding resin alone. The resin member may include an embedding resin and a foundation resin overlapping the embedding resin.

The base resin layer of the resin member may include a first portion and a second portion thinner than the first portion. The conductor portion may include a first conductor provided on the first portion and a second conductor provided on the second portion. A part of the first conductor may be exposed to the first surface of the resin member. A part of the second conductor may be exposed to the second surface of the resin member.

A connection conductor for electrically connecting the first conductor and the second conductor may be provided. A ground conductor for electrically connecting the metal base and the conductor portion may be provided. A pedestal member may be provided on the slider support portion. The slider is provided on the pedestal member. A pedestal member integral with the resin member may be provided on the resin member. The slider is provided on the pedestal member.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a suspension of the first embodiment.

FIG. 2 is a plan view showing a part of this suspension.

FIG. 3 is a cross-sectional view showing an example of a disk drive.

FIG. 4 is a cross-sectional view of a slider arrangement portion along F4-F4 line in FIG. 2.

FIG. 5 is a cross-sectional view of the slider arrangement portion along F5-F5 line in FIG. 4.

FIG. 6 is a cross-sectional view of a slider arrangement portion of the second embodiment.

FIG. 7 is a cross-sectional view of a slider arrangement portion of the third embodiment.

FIG. 8 is a cross-sectional view of a slider arrangement portion of the fourth embodiment.

FIG. 9 is a cross-sectional view of a slider arrangement portion of the fifth embodiment.

FIG. 10 is a cross-sectional view of a slider arrangement portion of the sixth embodiment.

FIG. 11 is a cross-sectional view of a slider arrangement portion of the seventh embodiment.

FIG. 12 is a cross-sectional view of a slider arrangement portion of the eighth embodiment.

FIG. 13 is a cross-sectional view of a slider arrangement portion of the ninth embodiment.

FIG. 14 is a cross-sectional view of a slider arrangement portion of the tenth embodiment.

FIG. 15 is a cross-sectional view of a slider arrangement portion of the eleventh embodiment.

FIG. 16 is a cross-sectional view of a slider arrangement portion of the twelfth embodiment.

FIG. 17 is a cross-sectional view of a slider arrangement portion of the thirteenth embodiment.

FIG. 18 is a cross-sectional view of a slider arrangement portion of the fourteenth embodiment.

FIG. 19 is a cross-sectional view of a slider arrangement portion of the fifteenth embodiment.

FIG. 20 is a cross-sectional view of a slider arrangement portion of the sixteenth embodiment.

### DETAILED DESCRIPTION OF THE INVENTION

### First Embodiment

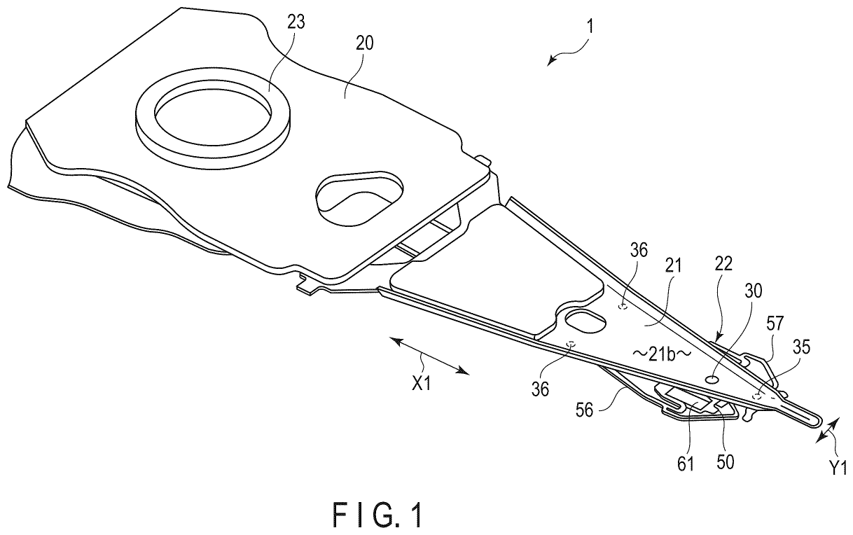

The following describes a suspension comprising a slider arrangement portion of the first embodiment with reference to FIG. 1 to FIG. 5.

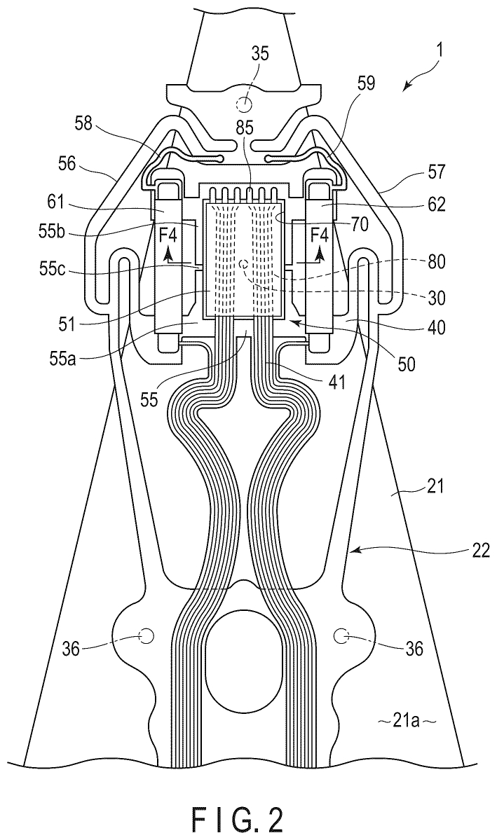

FIG. 1 is a perspective view of a suspension 1. FIG. 2 is a plan view of a part of the suspension 1. Double-headed arrow X1 in FIG. 1 indicates the length direction of the suspension 1. Double-headed arrow Y1 in FIG. 1 indicates the width direction of the suspension 1.

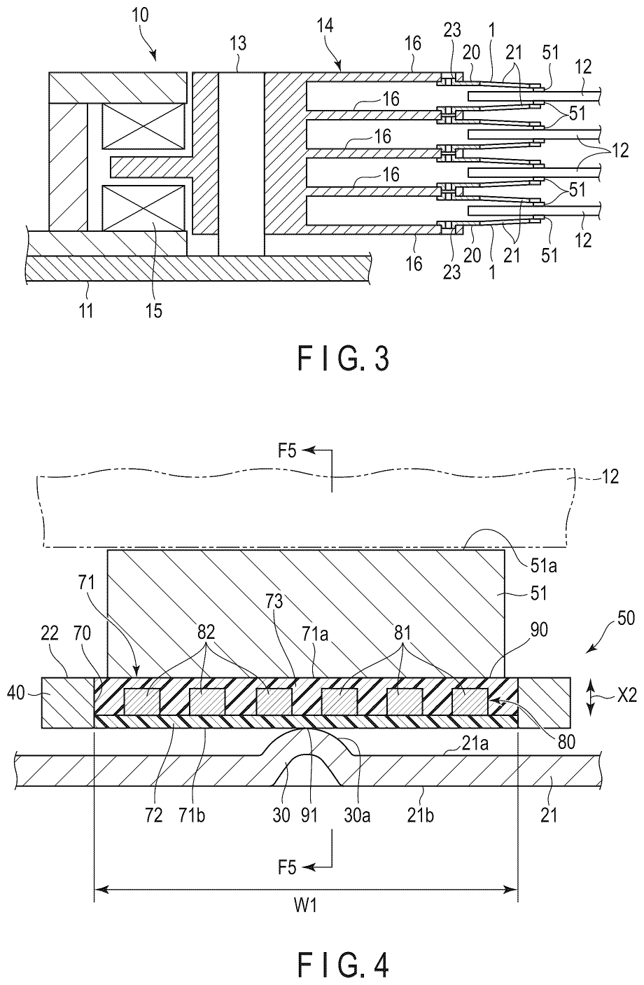

FIG. 3 is a cross-sectional view schematically showing an example of a disk drive 10. The disk drive 10 comprises a casing 11 (partially shown), a disk 12 rotating around a spindle, a carriage 14, a positioning motor 15, and the like. The carriage 14 pivots around a pivot 13. The motor 15 drives the carriage 14. A lid hermetically seals the casing 11. The suspension 1 is attached to the tip portion of an arm 16 of the carriage 14.

As shown in FIG. 1 and FIG. 2, the suspension 1 includes a baseplate 20, a load beam 21, and a flexure 22. The baseplate 20 is formed of, for example, a plate of stainless steel. A boss portion 23 of the baseplate 20 is secured to the carriage 14 (shown in FIG. 3). For example, the baseplate 20 has a thickness of 100 to 300 μm. The thickness is not limited to these values.

The load beam 21 extends in the length direction of the suspension 1. For example, the load beam 21 has a thickness of 20 to 40 μm. The thickness is not limited to these values. The load beam 21 has a first face 21a on which the flexure 22 is provided, and a second face 21b opposite to the first face 21a.

A dimple portion 30 is formed near the tip of the load beam 21. The dimple portion 30 includes a protrusion portion 30a. The protrusion portion 30a protrudes from the first face 21a of the load beam 21 to the flexure 22. The dimple portion 30 is inwardly bent from the second face 21b of the load beam 21. Thus, the protrusion portion 30a is called a dimple as well in the industry. The protrusion portion 30a protrudes toward the flexure 22.

The flexure 22 is secured to the load beam 21 by welding portions 35 and 36 (partially shown in FIG. 1 and FIG. 2). The flexure 22 extends along the load beam 21 in the length direction of the suspension 1. The flexure 22 includes a metal base 40 and a circuit portion 41. The metal base 40 is formed of a stainless-steel plate thinner than the load beam 21. The circuit portion 41 is arranged on the surface of the metal base 40. The metal base 40 has a thickness of, for example, 20 μm (12 to 25 μm). The thickness is not limited to these values.

A slider arrangement portion 50 is formed near the tip of the flexure 22. A slider 51 functioning as a magnetic head is provided on the slider arrangement portion 50. The slider 51 is provided with elements for magnetically recording data on the disk 12, elements for reading data recorded on the disk 12, and the like.

The slider arrangement portion 50 includes a plate portion 55 composed of a part of the metal base 40. The plate portion 55 is called a tongue as well in the industry. The plate portion 55 of the present embodiment is supported by arm portions 56 and 57, limiter portions 58 and 59, and the like such that the plate portion 55 is swingable with respect to the load beam 21. The plate portion 55 includes a first plate 55a and a second plate 55b. The first plate 55a and the second plate 55b each can slightly move in the width direction of the suspension 1 with respect to a slit 55c.

Actuator elements 61 and 62 are provided on respective sides of the slider 51. Each of the actuator elements 61 and 62 is formed of a piezoelectric body such as zirconate titanate (PTZ). When a voltage is applied to the actuator elements 61 and 62, a piezoelectric body extends and contracts in accordance with the applied voltage. Thus, the tip side of the slider 51 can be slightly moved in the width direction (direction indicated by the Double-headed arrow Y1 in FIG. 1) of the suspension 1. Elements for reading and writing of data are provided on the tip side of the slider 51.

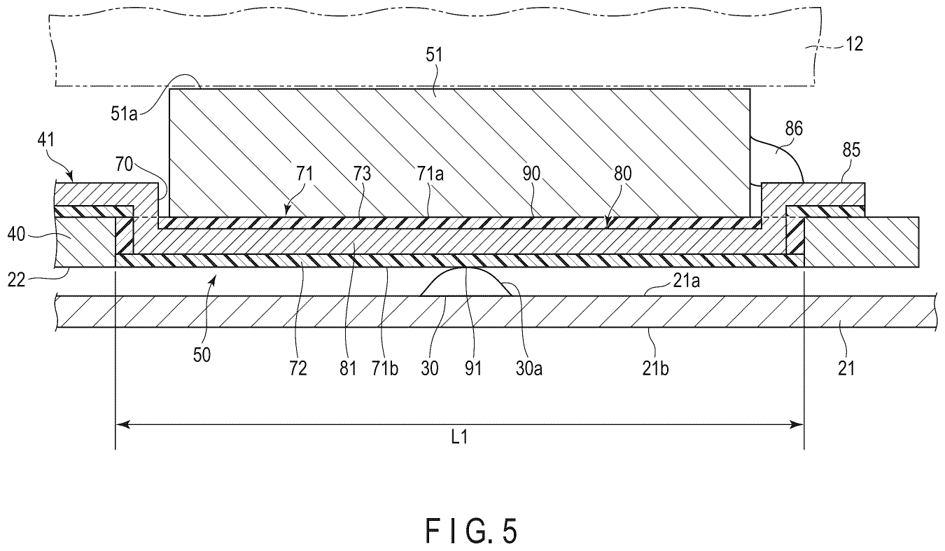

FIG. 4 is a cross-sectional view of the slider arrangement portion 50 along F4-F4 line in FIG. 2. FIG. 5 is a cross-sectional view of the slider arrangement portion 50 along F5-F5 line in FIG. 4. The slider arrangement portion 50 includes an aperture portion 70 formed in the metal base 40. The aperture portion 70 is formed in a position on which the slider 51 is provided and is open toward the thickness direction of the metal base 40. A width W1 (shown in FIG. 4) of the aperture portion 70 is greater than the width of the slider 51. A length L1 (shown in FIG. 5) of the aperture portion 70 is longer than the length of the slider 51.

A resin member 71 formed of an electrically insulating resin is formed inside the aperture portion 70. The resin member 71 of the present embodiment includes a base resin layer 72 and an embedding resin 73. The base resin layer 72 is formed inside the aperture portion 70. The embedding resin 73 overlaps the base resin layer 72 inside the aperture portion 70. Each of the base resin layer 72 and the embedding resin 73 is formed of an electrically insulating resin such as polyimide.

As shown in FIG. 4 and FIG. 5, a conductor portion 80 is provided in the aperture portion 70. The conductor portion 80 includes a plurality of conductors (for example, a first conductor 81 and a second conductor 82). The first conductor 81 and the second conductor 82 are described as examples in the present embodiment. The number of the conductors and the shape are not limited to the examples to be described in the present embodiment. The conductor portion 80 is formed on the base resin layer 72 inside the aperture portion 70. The conductor portion 80 is embedded in the embedding resin 73.

The conductor portion 80 constitutes a part of the circuit portion 41 in the length direction. A terminal portion 85 (shown in FIG. 2 and FIG. 5) and an electrically conductive member 86 electrically connect the conductor portion 80 to a terminal of the slider 51. The conductors 81 and 82 are mainly formed of copper. A plated layer of gold and the like is provided outside copper as necessary. To simplify the figures, the illustration of the plated layer is omitted in the figures. The plated layer may not be provided on the conductor. The conductors 81 and 82 are embedded in the embedding resin 73, which fills the aperture portion 70.

As an example, the resin member 71 is composed of the base resin layer 72 and the embedding resin 73. Double-headed arrow X2 in FIG. 4 indicates the thickness direction of the resin member 71. The resin member 71 has a first surface 71a in the thickness direction and a second surface 71b in the thickness direction. A slider support portion 90 is formed on the first surface 71a. The slider support portion 90 is substantially flat. The slider 51 is secured to the slider support portion 90 by bonding.

An abutting portion 91 is formed on the second surface 71b of the resin member 71. The protrusion portion 30a (substantially the apex of the dimple portion 30) contacts the abutting portion 91. The protrusion portion 30a is formed on the load beam 21 and protrudes toward the slider arrangement portion 50. The slider arrangement portion 50 can swing around the protrusion portion 30a in the thickness direction of the metal base 40.

The slider arrangement portion 50 of the present embodiment has the slider support portion 90 formed on the first surface 71a of the resin member 71. The resin member 71 fills the aperture portion 70. The first surface 71a is substantially flat. In formation of the embedding resin 73, an uncured embedding resin 73 is supplied to the aperture portion 70. The surface of the embedding resin 73 supplied to the aperture portion 70 is flatten by jigs such as a squeegee. This can form the slider support portion 90 that is flat and has no irregularities.

The slider 51 is arranged on the slider support portion 90. This arrangement stables the orientation of the slider 51. Thus, the distance between the disk 12 and an air bearing formation surface 51a (flying height of the slider) can be accurately controlled. The flying height of the slider is extremely small. Thus, accurate control of the orientation of the slider 51 is crucial.

According to the slider arrangement portion 50 of the present embodiment, the conductor portion 80 is embedded in the resin member 71 filling the aperture portion 70. Further, the slider 51 is provided on the first surface 71a of the resin member 71. The protrusion portion 30a (the apex of the dimple) contacts the second surface 71b of the resin member 71. Thus, the distance between the apex of the dimple and the air bearing formation surface 51a can be reduced. This contributes to providing a slider arrangement portion 50 that is low profile. Further, the slider 51 and the conductor portion 80 overlap in the thickness direction. Thus, the width of the slider arrangement portion 50 can be reduced.

The rotation of the disk 12 produces an air bearing between the disk 12 and the slider 51. Pivoting of the carriage 14 caused by the positioning motor 15 (shown in FIG. 3) moves the suspension 1 in the radial direction of the disk 12. The slider 51 is thereby moved to a desired position on the disk 12. When a voltage is applied to the actuator elements 61 and 62, the actuator elements 61 and 62 extend and contract. Thus, the tip side of the slider 51 can be moved in the width direction (direction indicated by the Double-headed arrow Y1 in FIG. 1) accurately and rapidly.

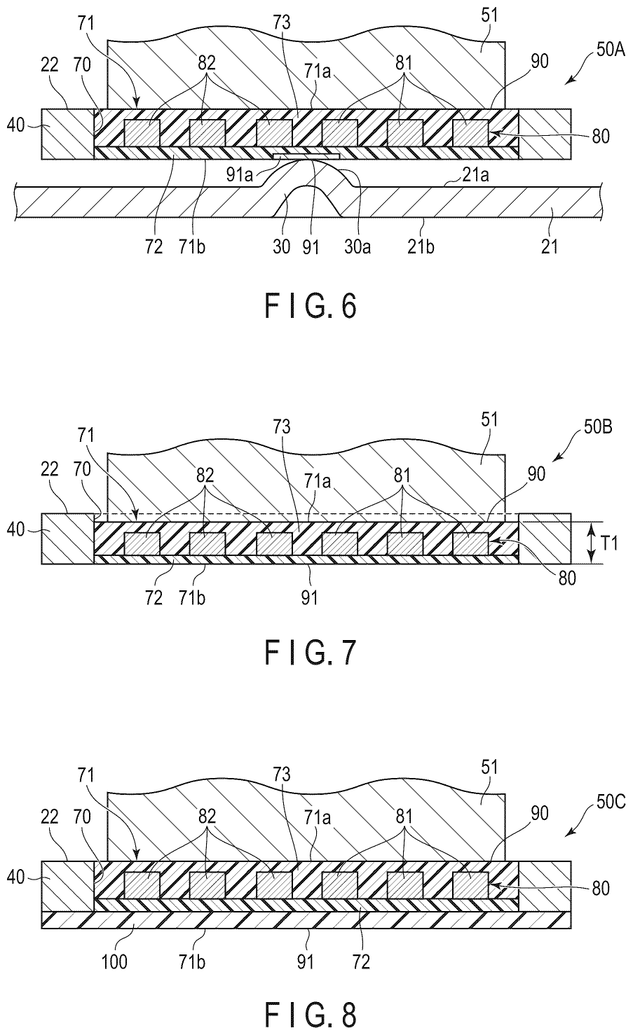

The following describes slider arrangement portions of the second embodiment to the sixteenth embodiment with reference to FIG. 6 to FIG. 20. In these embodiments, the same reference numerals are added to the constituent elements that the slider arrangement portion 50 of the first embodiment and those of these embodiments have in common. Explanations of these elements are omitted.

### Second Embodiment

FIG. 6 is a cross-sectional view of a slider arrangement portion 50A of the second embodiment. The slider arrangement portion 50A has an auxiliary member 91a provided on an abutting portion 91 of a resin member 71. The auxiliary member 91a is formed of a material (such as a metal) more rigid than the resin member 71. A protrusion portion 30a of a dimple portion 30 contacts the auxiliary member 91a.

### Third Embodiment

FIG. 7 is a cross-sectional view of a slider arrangement portion 50B of the third embodiment. A thickness Tl of a resin member 71 is smaller than the thickness of a metal base 40. In this case, a base resin layer 72 may be thinner, or an embedding resin 73 may be thinner. The reduction in the thickness Tl of the resin member 71 can further shorten the distance between the apex of the dimple and the air bearing formation surface of the slider.

### Fourth Embodiment

FIG. 8 is a cross-sectional view of a slider arrangement portion 50C of the fourth embodiment. A resin member 71 of the slider arrangement portion 50C includes a foundation resin 100. The foundation resin100 is formed of an electrically insulating resin such as polyimide. An abutting portion 91 is formed on the foundation resin 100. An embedding resin 73 overlaps a surface of a base resin layer 72 (the upper side surface in FIG. 8). A conductor portion 80 is embedded in the embedding resin 73. The foundation resin 100 overlaps the other surface of the base resin layer 72 (the lower side surface in FIG. 8).

### Fifth Embodiment

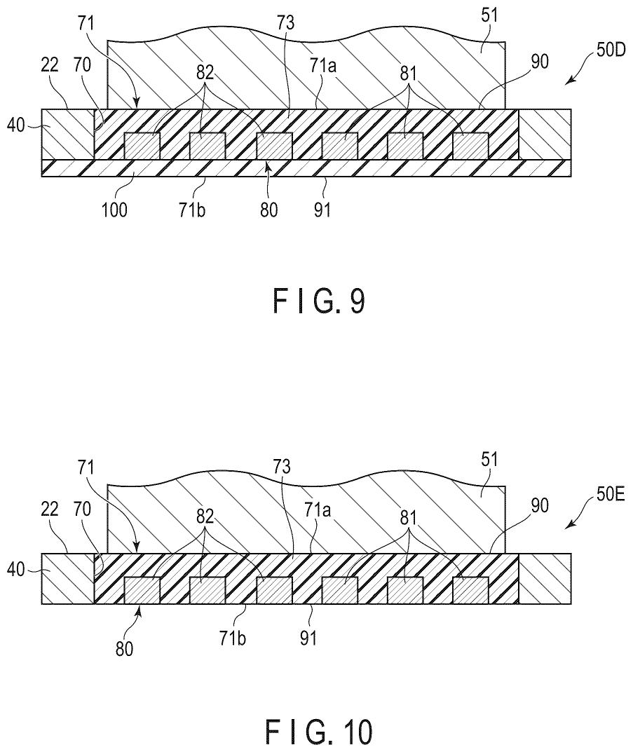

FIG. 9 is a cross-sectional view of a slider arrangement portion 50D of the fifth embodiment. The slider arrangement portion 50D does not include the base resin layer 72 described in the first embodiment. As shown in FIG. 9, the slider arrangement portion 50D includes a foundation resin 100. A conductor portion 80 is provided on the foundation resin 100. The conductor portion 80 is embedded in an embedding resin 73. An abutting portion 91 is formed on the foundation resin 100.

### Sixth Embodiment

FIG. 10 is a cross-sectional view of a slider arrangement portion 50E of the sixth embodiment. The slider arrangement portion 50E is different from that of the first embodiment in not including the base resin layer 72 described in the first embodiment. As shown in FIG. 10, a slider support portion 90 is formed on a first surface 71a of a resin member 71 composed of an embedding resin 73. An abutting portion 91 is formed on a second surface 71b of the resin member 71.

### Seventh Embodiment

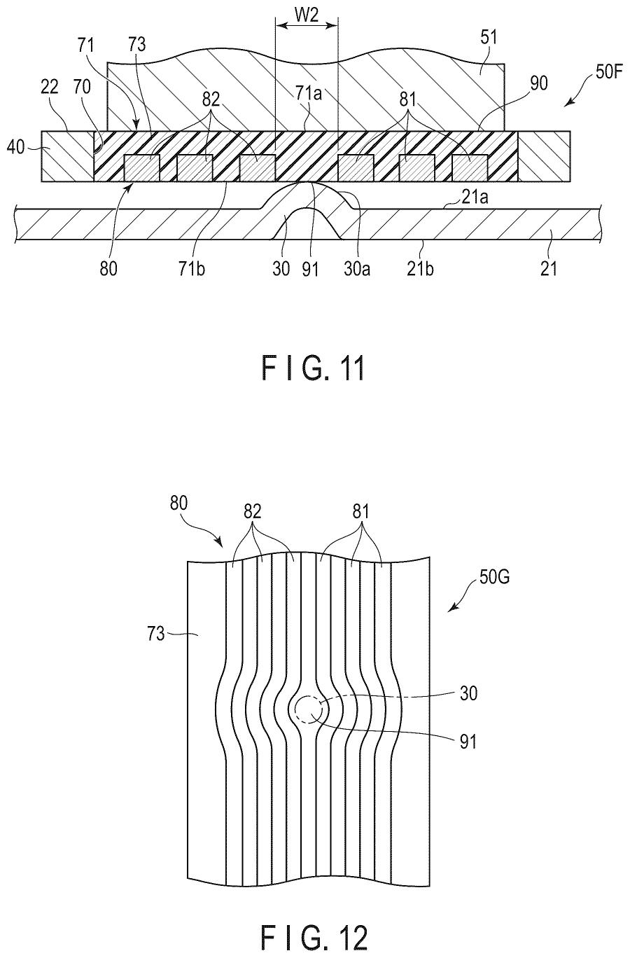

FIG. 11 is a cross-sectional view of a slider arrangement portion 50F of the seventh embodiment. The slider arrangement portion 50F has a distance W2 between the first conductor 81 and the second conductor 82. The distance W2 is larger than distances between other conductors. This configuration enables broadening electrically insulation distances between a dimple portion 30 and conductors 81 and 82.

### Eighth Embodiment

FIG. 12 is a plan view showing a part of a slider arrangement portion 50G of the eighth embodiment. A conductor portion 80 of the slider arrangement portion 50G is bent around the dimple portion 30 to bypass the dimple portion 30. This enables broadening the electrically insulation distance between the dimple portion 30 and the conductor portion 80.

### Ninth Embodiment

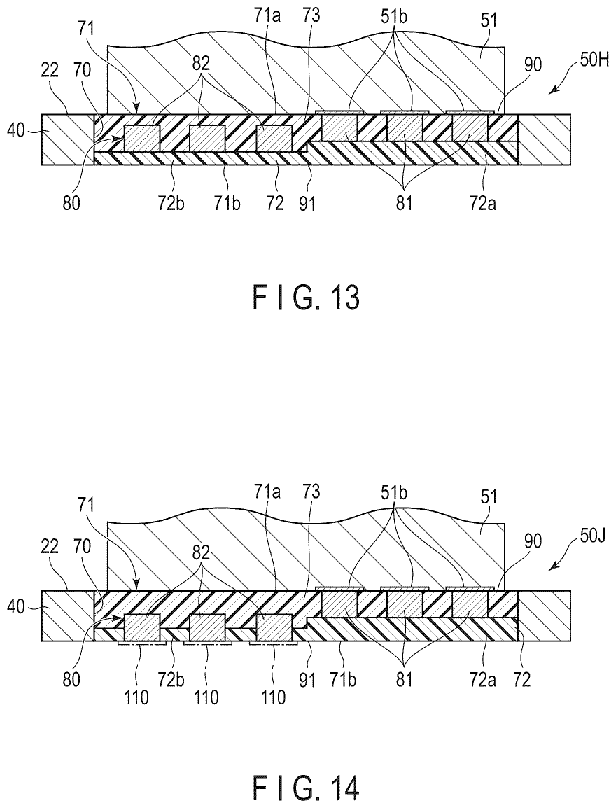

FIG. 13 is a cross-sectional view of a slider arrangement portion 50H of the ninth embodiment. As shown in FIG. 13, the base resin layer 72 has a first portion 72a and a second portion 72b thinner than the first portion 72a. A first conductor 81 is provided on the first portion 72a. A second conductor 82 is provided on the second portion 72b. A part of the first conductor 81 is exposed to a first surface 71a of a resin member 71. A rear surface side terminal (a top-bond pad) 51b of the slider 51 and the first conductor 81 are electrically connected to each other.

### Tenth Embodiment

FIG. 14 is a cross-sectional view of a slider arrangement portion 50J of the tenth embodiment. A base resin layer 72 has a first portion 72a and a second portion 72b, the second portion 72b being thinner than the first portion 72a. A first conductor 81 is provided on the first portion 72a. A second conductor 82 is provided on the second portion 72b. A part of the first conductor 81 is exposed to a first surface 71a of a resin member 71. A part of the second conductor 82 is exposed to a second surface 71b of the resin member 71. Thus, the second conductor 82 can be electrically connected to a terminal 110 of a flexure 22.

### Eleventh Embodiment

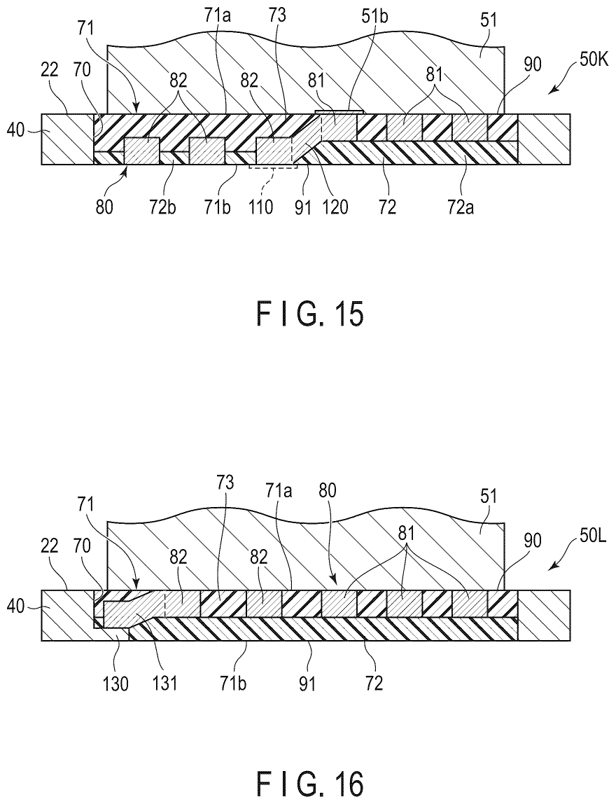

FIG. 15 is a cross-sectional view of a slider arrangement portion 50K of the eleventh embodiment. This slider arrangement portion 50K also includes a first portion 72a and a second portion 72b thinner than the first portion 72a. A first conductor 81 is provided on the first portion 72a. A second conductor 82 is provided on the second portion 72b. A connection conductor 120 electrically connects the first conductor 81 and the second conductor 82 adjacent to each other.

### Twelfth Embodiment

FIG. 16 is a cross-sectional view of a slider arrangement part 50L of the twelfth embodiment. As shown in FIG. 16, a ground conductor 130 is provided on a metal base 40. A connection conductor 131 electrically connects a second conductor 82 and the ground conductor 130.

### Thirteenth Embodiment

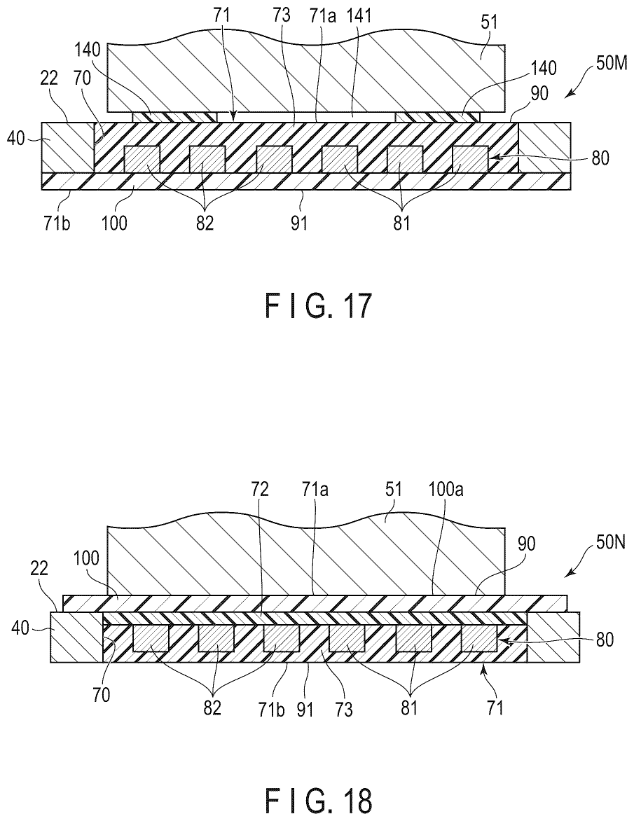

FIG. 17 is a cross-sectional view of a slider arrangement portion 50M of the thirteenth embodiment. The slider arrangement portion 50M includes a pedestal member 140. The pedestal member 140 is provided on a flat slider support portion 90. An embedding resin 73 and a foundation resin 100 constitute a resin member 71. Uncured liquid adhesive fills a gap 141 between a slider 51 and the embedding resin 73. This adhesive cures, fixing the slider 51. The foundation resin 100 may not be provided.

### Fourteenth Embodiment

FIG. 18 is a cross-sectional view of a slider arrangement portion 50N of the fourteenth embodiment. A slider 51 is provided on a flat surface 100a of a foundation resin 100. A resin member 71 fills an aperture portion 70. The resin member 71 is composed of a base resin layer 72 and an embedding resin 73. A conductor portion 80 is embedded in the resin member 71. A slider 51 is provided on the flat surface 100a of the foundation resin 100. This configuration stables the orientation of the slider 51.

### Fifteen Embodiment

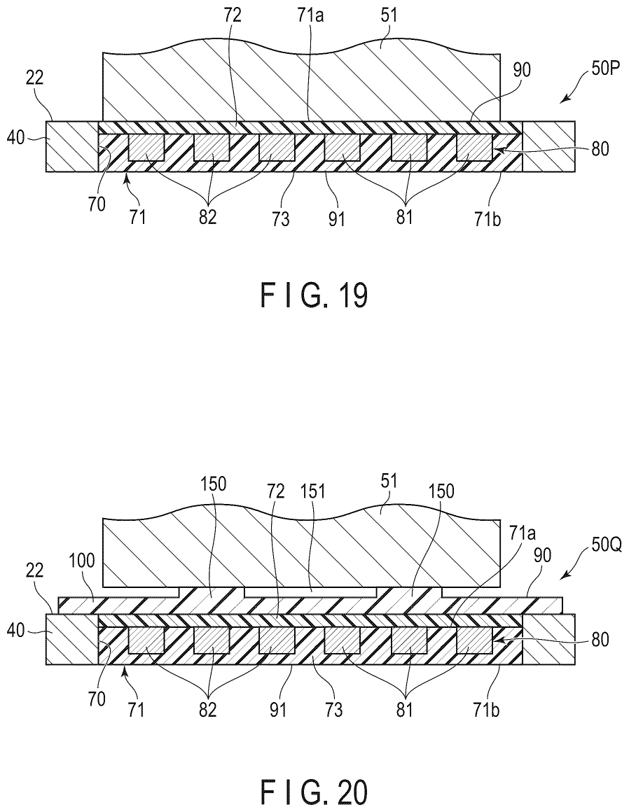

FIG. 19 is a cross-sectional view of a slider arrangement portion 50P of the fifteenth embodiment. As shown in FIG. 19, a base resin layer 72 and an embedding resin 73 constitute a resin member 71. A slider support portion 90 is formed on the base resin layer 72. An abutting portion 91 is formed on the embedding resin 73. A pedestal member 140 shown in FIG. 17 is provided between the base resin layer 72 and a slider 51.

### Sixteenth Embodiment Embodiment

FIG. 20 is a cross-sectional view of a slider arrangement portion 500 of the sixteenth embodiment. The slider arrangement portion 500 includes a pedestal portion 150 integrally formed with a foundation resin 100. A gap 151 is formed between a slider 51 and the foundation resin 100. Uncured liquid adhesive fills the gap 151. This adhesive cures, fixing a slider 51.

Each of the above-described slider arrangement portions 50, 50A to 50H, and 50J to 50Q includes the aperture portion 70, the resin member 71, and the conductor portion 80. The aperture portion 70 is open in the thickness direction of the metal base 40. The resin member 71 fills the aperture portion 70. The conductor portion 80 is embedded in the resin member 71. The flat slider support portion 90 is formed on the resin member 71. This configuration enables stable orientation of the slider 51. Further, no metal base 40 is provided between the abutting portion 91 and the slider 51. This configuration shortens the distance between the apex of the dimple and the air bearing formation surface.

Needless to say, when implementing the present invention, the configuration of each element, such as the metal base and circuit portion constituting the flexure can be modified variously. In addition, the aperture portion formed in the slider arrangement portion, the resin member, the slider support portion, and the abutting portion can also be implemented in various forms, as long as they do not deviate from the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive suspension comprising:
a load beam; and
a flexure, wherein the flexure includes:
a metal base;
a slider arrangement portion on which a slider is arranged; and
a circuit portion electrically connected to the slider,
the slider arrangement portion includes:
an aperture portion formed in a position on which the slider is arranged and open in a thickness direction of the metal base;
a resin member filing the aperture portion;
a conductor portion embedded in the resin member in a part of the circuit portion;
a slider support portion, which is formed on a first surface of a thickness direction of the resin member and on which the slider is arranged; and
an abutting portion formed on a second surface of the thickness direction of the resin member and contacting a protrusion portion of a dimple portion of the load beam.

2. The suspension of claim 1, wherein
the resin member includes:
a base resin layer formed inside the aperture portion; and
an embedding resin embedding the conductor portion with overlapping the base resin layer.

3. The suspension of claim 1, wherein
an auxiliary member contacting the protrusion portion is provided on the abutting portion.

4. The suspension of claim 1, wherein
the resin member is thinner than the metal base.

5. The suspension of claim 1, wherein
the resin member includes:
a base resin layer formed inside the aperture portion;
an embedding resin embedding the conductor portion with overlapping a surface of the base resin layer; and
a foundation resin overlapping an opposite surface of the base resin layer.

6. The suspension of claim 1, wherein
the resin member is composed of an embedding resin filling the aperture portion and embedding the conductor portion.

7. The suspension of claim 1, wherein
the resin member includes:
the embedding resin filling the aperture portion and embedding the conductor portion; and
a foundation resin overlapping the embedding resin.

8. The suspension of claim 2, wherein
the base resin layer of the resin member includes:
a first portion; and
a second portion thinner than the first portion, and
the conductor portion includes:
a first conductor provided on the first portion; and
a second conductor provided on the second portion.

9. The suspension of claim 8, wherein
a part of the first conductor is exposed to the first surface of the resin member.

10. The suspension of claim 8, wherein
a part of the second conductor is exposed to the second surface of the resin member.

11. The suspension of claim 8, further comprising:
a connection conductor electrically connecting the first conductor and the second conductor.

12. The suspension of claim 1, further comprising:
a ground conductor electrically connecting the metal base and the conductor portion.

13. The suspension of claim 1, wherein
a pedestal member is provided on the slider support portion, and
the slider is provided on the slider support portion with the pedestal member sandwiched between the slider and the slider support portion.

14. The suspension of claim 1, wherein
a pedestal member integrally formed with the resin member is provided on the resin member, and
the slider is provided on the slider support portion with the pedestal member sandwiched between the slider and the slider support portion.
